(19) United States
(12) Patent Application Publication
(10) Pub. No.: US 2006/0036820 A1
(43) Pub. Date: Feb. 16, 2006

(54) Data storage system

(75) Inventors: Arata Ejiri, Kawasaki (JP); Mitsuhiko Ohta, Kawasaki (JP); Toru Yokohata, Kawasaki (JP); Atsuo Iida, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/256,911

(22) Filed: Oct. 24, 2005

Related U.S. Application Data
(63) Continuation of application No. PCT/JP04/10502, filed on Jul. 23, 2004.

(30) Foreign Application Priority Data
Jul. 24, 2003 (WO) PCT/JP03/09402

(51) Int. Cl. G06F 12/00; G06F 15/16

(52) U.S. Cl. 711/158; 711/114; 709/203

(57) ABSTRACT

There are connected a plurality of hosts 1 to L, a plurality of targets 1 to M and a plurality of initiators 1 to N, through a network. Each target has a managing unit which decides by itself the target search information broadcast from the initiator onto the network. In the case it is suited for data storage in the own target, data storage response information containing accepted priority information is broadcast onto the network. The target largest in priority value is notified of target selection from the initiator, thus effecting data storage.

### CROSS-REFERENCE TO RELATED APPLICATION

This application is a continuation application of PCT/JP2004/010502, filed on Jul. 23, 2004.

### TECHNICAL FIELD

The present invention relates to a data storage system including a plurality of data storage devices connected to a network and, more particularly, to a data storage system that is further improved in system reliability by autonomously effecting data write and read through an autonomous search for a destination for data saving in a plurality of connected data storage devices instead of having a centralized management server, and is reduced in management cost for the data storage devices due to occupied amount equalization and access dispersion in storing data to the plurality of data storage devices, thereby reducing the management cost of the data storage devices.

### BACKGROUND ART

Conventionally, there is frequently used a computer system that connects the central processing unit and storage devices by a network such as a LAN. In the computer system, data is transmitted between the central processing unit and the storage device by use of a network protocol as a communication protocol. Multiplexing of storage data is realized by copying data to a plurality of storage devices by using an exclusive multiplexer or by separately issuing a data write request to a plurality of storage devices from the central processing unit.

In the multiplexed data management, data backup is done by multiplexing data for the storage device, e.g. by configuring a RAID configuration with a plurality of storage devices such as magnetic disks, by configuring a mirror ring, etc. by having a multiplicity of storage devices, or by duplexing data within a single storage device. System reliability is improved by adopting these approaches.

Meanwhile, recent computer systems are expected to improve their process performances. By centralizing distributed computers and storage devices in a data center into a configuration of a computer system and storage system, it is possible to reduce the cost required for system operation, maintenance and management. In the centralized management of the data center, there are effected data optimal arrangement, failed storage device removal, data movement to a new storage device, and so on.

Various developments are now underway as to how to carry out centralized management in such a computer system. For example, JP-A-11-212844 discloses a computer system that, when registering data from a host, a data management unit in a master automatically duplicates data for a slave. In the computer system, the master, having a network function unit therein, is connected to a slave for backup located distant. During registering data, the data managing unit of within the master automatically performs a backup operation onto an optical disk within the backup slave, without host intervention, simultaneously with a registration to the in-master optical disk, thus effecting data duplexing.

Meanwhile, JP-A-2000-267979 discloses a computer system connecting a central processing unit, and a plurality of storage devices, through a LAN. In the system, storage device multiplexing and hierarchization is realized by exchanging a storage domain secure request frame, a storage domain secure response frame, a data write request frame, a data write response frame, a data read request frame, a data read response frame, a storage domain release request frame and a storage domain release request frame, through broadcast or multicast.

Furthermore, JP-A-2001-34426 discloses a data-processor-control-type data storage system having a system for storing data in a plurality of logic volumes each of which is to be divided into a plurality of mirror logic data segments. This system, adapted to be placed in dynamical synchronization when a storage system trouble occurs, includes means for resynchronizing each of the plurality of logic volumes, means for accessing data not resynchronized from one of the logic volumes, and means for copying the access data to a mirror segment.

Meanwhile, JP-A-2001-282628 discloses a non-synchronous type remote copy system that, in order to geminate the data of a disk subsystem of a main center, data consistency is assured by only the disk subsystem function to thereby make a copy to the disk subsystem of the remote center.

JP-A-2002-182864 discloses a disk array system that a plurality of disk array control devices are made to operate as one disk array control device to thereby exhibit a performance proportional to the number thereof while suppressing the performance reduction due to data transfer between the plurality of disk array control devices.

However, in these computer systems, the host computer or the master computer is to perform a data management for the storage devices. Because the storage device has increased in size with the recent increase of data amount, there arises a need for data management based on a complicated protocol. Furthermore, in the size increase, the system is further complicated, e.g. storage devices are added to the existing equipment. Manager education for that purpose is required and is troublesome and a burden. Accordingly, there is encountered the increase in management cost, wherein a limit is reached in centrally managing the storage devices separately arranged in the computer system.

Therefore, it is an object of the present invention to realize, in a data storage system connected with a plurality of computers and a plurality of data storage devices through a network, a data storage management by the data storage device itself and a cooperation management with another data storage device depending upon the information broadcast over to a network, by providing data storage devices with a data managing function. A data storage system is provided which satisfactorily does not require a centralized management on a plurality of data storage devices from the host side, but allows it to effect an autonomous management on the data storage devices while equalizing the occupied amount of the data storage devices and dispersing the accesses to the data storage devices.

### DISCLOSURE OF THE INVENTION

In order to solve the above problem, the present invention is a data storage system, connected to a network and having a plurality of data storage devices for storing data related to a host computer, the data storage system wherein the plurality of data storage devices respectively having managing units for managing the data storage devices of the owns, the managing unit comprising: a search response unit for deciding whether or not an data storage amount based on the data storage search information is suited for data storage in the own data storage device when data storage search information sent onto the network is received; and an accepted information processing unit for producing accepted priority information about the own data storage device in a case the storage data amount is suited for data storage in the own data storage device; the managing unit sending the accepted priority information onto the network by including same in data storage response information to the data storage search information, and autonomously storing the data to the own data storage device. The managing unit is configured having a target search unit capable of broadcasting the data storage search information onto the network in order to store data in another data storage device connected to the network.

The target search unit is configured to receive the data storage response information sent from the other data storage device in response to the data storage search information broadcast onto the network, and selects a data storage device for storing data depending upon the accepted priority information contained in the data storage response information. Furthermore, the target search unit is configured to count time up to a return of the data storage search information broadcast onto the network, and adjusts a wait time for receiving the data storage response information depending upon the time counted.

The target search unit is configured to select data storage devices in order the greatest in priority value concerning the accepted priority information included in the data storage response information received.

Meanwhile, the target search unit is configured to send data storage search information to the plurality of data storage devices by a simultaneous broadcast onto the network, sends selected-out notification information to the data storage device responded for suitable data storage as to the data storage search information, and receives data suitability/non-suitability response information about data storage to the selected-out notification information from the data storage device.

Meanwhile, the accepted priority information is an available capacity of the own data storage device upon receiving the data storage search information.

The accepted priority information is an unoccupied ratio of the own data storage device upon receiving the data storage search information. The access coefficient is determined by multiplying an access parameter in a predetermined value of 1 or smaller on an initial value of the access coefficient in a case the own data storage device has been selected during a data storage in a last time, and is determined by dividing the unoccupied ratio by the access parameter in a case the own data storage device has not been selected during the data storage in the last time. Otherwise, the access coefficient is determined by multiplying an access parameter in a predetermined value of 1 or smaller on an initial value of the access coefficient in a case the own data storage device has been selected during a data storage in a last time, and determined by adding the initial value to a value the access parameter is multiplied on a difference between a value 1 and the initial value in a case the own data storage device has not been selected during a data storage in the last time.

Meanwhile, when the accepted information processing unit, in the middle of the data storage, detects an additional connection of a data storage device having an available capacity greater than an available capacity of each of the data storage devices excepting the plurality of data storage devices, the priority index of the accepted priority information after detection is rendered as an unoccupied ratio that an unoccupied amount upon reception of the data storage search information is divided by an available capacity of the own data storage device upon the detection.

Meanwhile, when the accepted information processing unit, in a mid course of the data storage, detects an additional connection of a data storage device having an available capacity greater than an available capacity of each of the data storage devices excepting the plurality of data storage devices, the priority index of the accepted priority information after detection is determined by multiplying a random value of 1 or smaller on an unoccupied ratio of the own data storage device.

Furthermore, when the accepted information processing unit, in the middle of the data storage, detects an additional connection of a data storage device having an available capacity greater than an available capacity of each of the data storage devices excepting the plurality of data storage devices, the search response unit randomly delays transmission timing of the data storage response information including accepted priority information of after the detection.

Meanwhile, the target search unit calculates, depending upon a priority value included in accepted priority information of the data storage response information received from another data storage device, a probability commensurate with a magnitude of the priority value, and randomly selects the other data storage device according to the probability.

The managing unit, after receiving selected-out notification information responded to the data storage response information sent out, performs write, read or erase as to the own data storage device depending upon a process request included in the data storage search information.

Meanwhile, in a data storage system according the invention, an initiator is provided for receiving an instruction from the host computer through the network and sending the data storage search information to a plurality of data storage device under jurisdiction associatively with the instruction by a simultaneous broadcast onto the network.

The managing unit, in the case the data storage search information is suited for data storage in the own data storage device, sends the data storage response information about the own data storage device to the initiator through the network.

Meanwhile, the initiator is configured to send selected-out notification information about selecting the data storage device to the data storage device depending upon accepted priority information included in the data storage response information sent from the data storage device, the managing unit of the data storage device, when receiving the selected-out notification information, sends data suitability/non-suitability information to the initiator in a case the data storage search information is suited for data storage in the own data storage device.

The managing unit, in a case including data suitability response in the data suitability/non-suitability response information, performs write, read or erase data concerning the data storage search information to or from the own data storage device. In a case data suitability/non-suitability response is included from the data storage device sent out the selected-out notification information, a next candidate of data storage device is selected depending upon another data storage response information sent out and forwarding selected-out notification information to the other data storage device.

### BRIEF DESCRIPTION OF THE DRAWINGS

FIG. 1 is a figure showing a system arrangement according to a data storage system of the present invention.

FIG. 2 is a figure explaining a functional arrangement of one target connected in the data storage system of the present invention.

FIG. 3 is a flowchart explaining a basic process procedure of target search in the data storage system of the present invention.

FIG. 4 is a graph explaining the manner of saving data in a plurality of targets equal in storage capacity.

FIG. 5 is a graph explaining the manner of saving data in a plurality of targets not equal in storage capacity.

FIG. 6 is a graph explaining the manner of data storage in the case another target is added, in the course, to the plurality of targets equal in storage capacity.

FIG. 7 is a graph explaining a concrete example improved in the manner of data storage in the case of shown in FIG. 6.

FIG. 8 is a graph explaining another concrete example improved in the manner of data storage in the case of shown in FIG. 6.

FIG. 9 is a graph explaining the manner of data storage in the case another target is added, in the course, to the plurality of targets not equal in storage capacity.

FIG. 10 is a graph explaining a concrete example improved in the manner of data storage in the case of shown in FIG. 9.

FIG. 11 is a graph explaining the manner that a plurality of users simultaneously save data to a plurality of targets not equal in storage capacity.

FIG. 12 is a graph explaining a concrete example improved in the manner of data storage in the case of shown in FIG. 11.

FIG. 13 is a flowchart explaining in detail the target search procedure in the data storage system of the invention shown in FIG. 3.

FIG. 14 is a flowchart in an embodiment explaining the target search procedure in the generation of a data save request in the data storage system in the present embodiment.

### BEST MODE FOR CARRYING OUT THE INVENTION

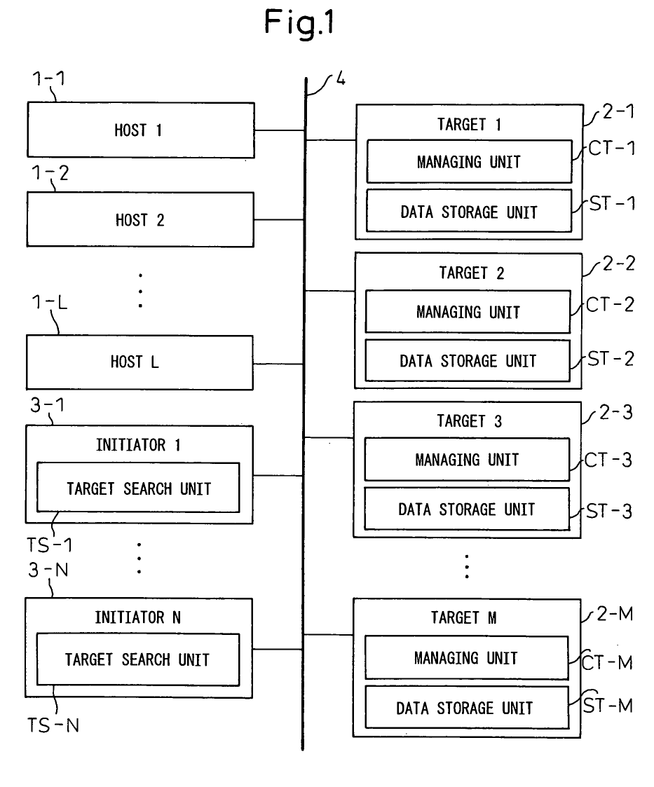

A data storage system of the present invention will be explained which has a plurality of data storage devices separately arranged through a network, to provide a data management function on the data storage device itself, thereby realizing data storage management and cooperation management by the data storage device itself with another data storage device depending upon the information broadcast onto the network. FIG. 1 shows an embodiment of the data storage system, which shows the overview of the overall arrangement of a computer network system allowing a plurality of computers and a plurality of data storage devices to operate cooperatively.

In FIG. 1, there are shown a plurality of computers 1-1 to 1-N as hosts 1 to L. Those hosts 1 to L are connected to a network 4, e.g. a LAN or the Internet, thus being connected for operating cooperatively one with another. The network 4 is connected with targets 2-1 to 2-M as a plurality of data storage devices 2-1 to 2-M separately arranged. In each of the targets, provided are data management units CT-1 to CT-M and a data storage unit ST-1 to ST-M. Furthermore, there are connected initiators 1 to N as interface devices 3-1 to 3-N in plurality having a function to search a target over a network protocol and instruct the data storage device to execute a processing. In this manner, a data storage system of this embodiment is formed by connecting a plurality of hosts 1 to L, targets 1 to M and initiators 1 to N with the network 4 and having mutual communications based on a network protocol.

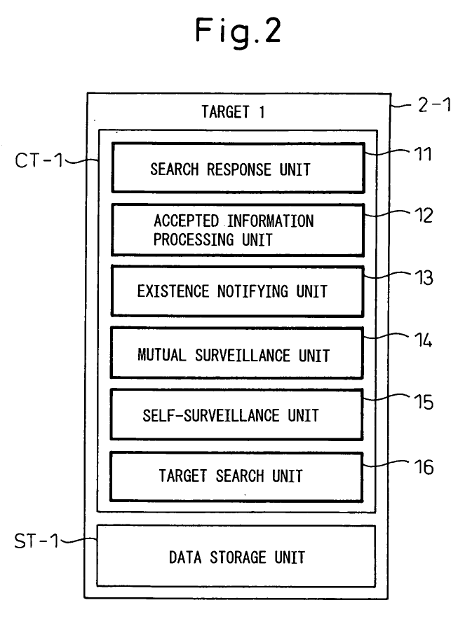

In FIG. 2, there is shown an internal configuration of each of the plurality of targets 1 to M provided in the data storage system. The targets 1 to M in plurality are identical in configuration and hence the target 1 as the interface device 2-1 is representatively shown of its configuration in the figure. In any of the targets, provided is a data management unit CT-1 including, as means for managing the self-target, a search response unit 11, an accepted information processing unit 12, an existence notifying unit, a mutual surveillance unit 14, a self-surveillance unit 15 and a target search unit 16. Furthermore, a data storage unit ST-1 is provided as a data storage device to store data.

The data storage unit ST-1, in the respective targets, may be equal in size and in speed on each target, or in a combination of those different in size and in speed. Meanwhile, the data storage unit may use a magnetic disc recording device, a semiconductor memory device, a magnetic tape recording devices or the like, which may be the same in kind or different in kind from target to target. The data storage unit can respond to a read or write request from the host.

The search response unit 11 in each target has a function that, in the case one of the initiators are searching a target capable of performing a processing, a response is made as to whether or not the processing can be executed for the search request. It further has a function that, in the case the data storage devices are set multiplexed within the data storage system, when another target searches an opposite to be multiplexed with the relevant target through the network 4, response is made to the search request.

The accepted information processing unit 12 has a function that, in the case the search response unit 11 responds to a search request which request is for data storage to the data storage unit ST-1, an accepted priority information is generated which represents an unoccupied status or empty status of the own data storage unit ST-1. When there is a search request from the external to the own target, the accepted priority information is supplied to the search response unit 11 and appended to a search request thereof. The detail of generating such accepted priority information will be referred to later with a concrete example.

The existence notifying unit 13 has a function that, in the case the data storage device is set multiplexed within the data storage system, e.g. when the own target is in a mirror-configuration relationship with another target, a response is made to an inquiry of from another target to thereby notify another target of a normal operation and existence free from trouble.

The mutual surveillance unit 14 has a function that, in the case the data storage unit ST-1 is set multiplexed within the data storage system, e.g. when the own target is in a mirror-configuration relationship with another target, an inquiry is made cooperatively with the existence notifying unit 13 of the other target to thereby autonomously survey whether the own target and the other target are normal in a relationship.

The self-surveillance unit 15 has a function to autonomously survey the operation state of the own target, e.g. a self surveillance routine is started up during operation of the own target and normal operation is available as a data storage device though there is a destruction in the data stored in the data storage unit of the own target.

Meanwhile, the target search unit 16 has a function to autonomously search an opposite target, in order to perform a copy, read, write and erase of data at between targets. It has a function that, when another target is inoperative because of failure or the like where the data storage device is set multiplexed within the data storage system, e.g. where the own target and another target are in a mirror-configuration relationship, autonomous search is made for an opposite target in the mirror configuration. The target search unit 16 of the relevant target cooperates with the mutual surveillance unit 14 and sends target search information by a simultaneous broadcast onto the network according to a network protocol.

As described above, each of the targets 1 to M connected to the network 4 is provided with the data managing unit CT-1 including the search response unit 11, accepted information processing unit 12, existence notifying unit 13, mutual surveillance unit, self surveillance unit 15 and target search unit 16, and the data storage unit ST-1. Between the targets, broadcast communication is performed according to a network protocol. The target is allowed to process a broadcast communication by itself, and autonomously maintain and restore a target relationship for multiplexing.

Meanwhile, the plurality of initiators 1 to N connected to the network 4 are interface devices having a function to request the data storage device to execute a process according to a processing request from the host 1 to L. As shown in FIG. 1, the initiators 1 to N respectively have target search units TS-1, . . . , TS-N.

The target search units TS-1, . . . , TS-N each have a function that, when a process execution instruction, e.g. data save request, is sent from any of the hosts 1, 2, . . . , L to the target through the network 4, the initiator itself autonomously searches for a target suited for the data save request over the network.

In the conventional data storage system, because there is a data save request designating a destination from the host, the initiator merely sends the data save request to the relevant target according to the destination. However, in the data storage system of this embodiment, the target search unit TS-1, . . . , TS-N is provided in the initiator. The target search unit is to simultaneously broadcast target search information onto the network thereby eliminating the host designating a destination so that the initiator itself can autonomously search for a target suited for the request issued from the host. Furthermore, the data managing unit CT-1 and the data storage unit ST-1 are provided on the target side. The target search unit 16 is provided also in the data managing unit CT-1 so that another target can be searched by broadcasting target search information onto the network. The management of the plurality of targets are simplified by enabling autonomous management of a cooperation with another target.

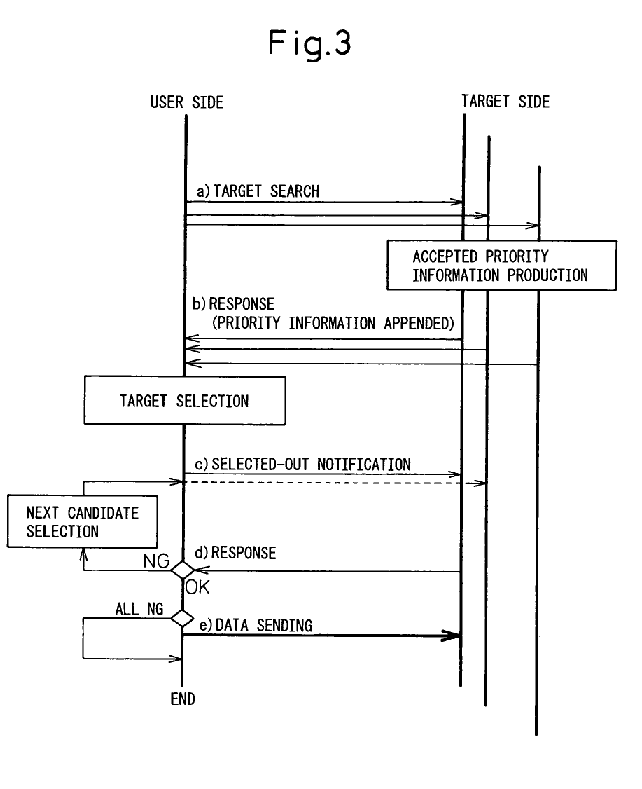

Referring to the flowchart in FIG. 3, explanation is now made on the basic process procedure concerning an autonomous target search in the data storage system of the invention configured as above. The flow shown in FIG. 3 illustrates a procedure of a search process in the case there is raised a need for any of the initiators 1 to N connected to the data storage system to search for another target. The search procedure is the basis of an autonomous target search in the data storage system of the invention. The side for requesting such a target search is representatively taken as a user side while the side for responding to such a search request is as a target side.

It is herein assumed that there is raised a need for the user to search for a target as a destination of data saving. In this case, on the user side, the target search unit provided to the user side starts an operation, to perform a target search over the network (a). In the target search unit, target search information is produced automatically according to a data save request sent to the user, in the case the data is stored on the target side or in the case the data saved by the user side is saved to the target side.

The target search information includes a command name meaning a target search and a number of LUNs (Logical Unit Number) representative of the size of storing data, being given with a code UDP representing not to confirm a response. The initiator N sends the produced target search information onto the network according to a network protocol, thus effecting a simultaneous broadcast.

Meanwhile, the targets receive the broadcast target search information by their search response units provided respectively. Thereupon, the accepted information processing unit decides an unoccupied status or empty status of the relevant data storage unit from the data storage amount in the target storage unit of the own target depending upon the received target search information, by referring to the number of LUNs contained in the received target search information. When there is an available capacity to store data in the own data storage unit, accepted priority information is generated. The accepted priority information includes a priority index to be referred later in detail. The priority index represents a degree of possibility that the target be selected on the user side.

Here, in the case the accepted information processing unit generated accepted priority information representing that there is an available space in the data storage unit of the own target, the search response unit produces response information in order to make a response to the target search information. The response information includes a command name representative of a response to a target search, accepted priority information, the remaining number of LUNs representative of an empty state and a communication protocol IP as to a source user. The accepted priority information may include various pieces of attribute information about the relevant target besides the priority index. For example, those include a manufacturer name, data transfer rate, performance information such as of recording density, error rate, a value representative of a state of temperature or the like, and so on.

Furthermore, the response information is given with a code UDP meaning not to confirm the response. The search response unit sends the produced response information onto the network 4 (b). In this case, when decided that, in a plurality of targets, there are available spaces appropriate in size for those of data to be stored in the respective data storage units, response information is broadcast onto the network 4 from each of the targets.

Then, the target search unit provided on the user side waits for receiving response information by way of the network 4 for, say, 10 seconds from a time point the user side has sent the target search information. The user-side target search unit, during waiting for a reception, receives response information including its own communication protocol IP and broadcast from target side, and stores the target IP and accepted priority information of the received response information. According to the target IP, targets are managed as selectable destinations of data saving.

Here, setting a wait time for receiving response information in the user-side target search unit is important in selecting the optimal destination of data saving by means of the response information replied to broadcast target search information broadcast onto the network by each target during a target search by the user side. In case the wait time is set short, response information is not returned from the target thus resulting in a failure of data saving. Meanwhile, if the wait time is long, data access per se is decreased in speed. There are possible cases that congestion abruptly occurs over the network due to a certain reason with a result of possibly a great delay in responding from the target. Thus, there is a need to set a wait time for reception to a suitable length.

Such a reception wait time is set up with reference to a time of returning to the own target search unit the target search information broadcast from the user-side target search unit onto the network. When information is broadcast onto the network, it usually is forwarded to itself, which is made use of to count a time up to a return of the target search information to itself. Because a communication status over the network is reflected in the time counted, this time is taken as a reference in adjusting the reception wait time. With such a reception wait time, it is possible to select a target as the optimal destination of data saving.

Then, the user-side target search unit selects a target as a destination of data saving depending upon the accepted priority information contained in those pieces of response information received. Although referred later as selecting a target as a destination of data saving by the target search unit, a target as the optimal destination of data saving is selected depending upon those pieces of accepted priority information. Thus, selected-out notification information is sent to the selected target through the network (c).

Incidentally, in the target selection method, selection is from the gathered pieces of response information according to accepted priority information. Alternatively, selection may be by using other pieces of attribute information in the response information.

Meanwhile, a target search must not be performed each time receiving a request for data saving. A search can be made at a proper interval regardless of saving request, to save gathered pieces of response information as a list so that, when requested for saving data, target selection is possible by referring to the list without performing a search. Meanwhile, after once producing a response information list, a search may be made at a time point a difference is surfaced between a list and actual state.

The selected-out notification information includes a command name representative of being selected as a destination of data saving, a number of LUNs representative of a size of data to be saved and data identification information about securing a domain, being given with a code TCP requiring a response confirmation. Here, the selected-out notification information sent from the user side includes again a number of LUNs is because of the reason, i.e. when the user sends selected-out notification information to the target, the relevant target is possibly changed in its data storage status. In a certain case, available capacity is possibly insufficient for a data saving request at a notification point of time. Accordingly, the target is caused to decide whether or not it is suited for data saving. Incidentally, the target side is required to again notify the size of saving data because the target search information received is not saved.

In FIG. 3, there is shown a case that target-side target is selected as a destination of data saving wherein selected-out notification information has been sent from the user side. Consequently, the search response unit in the relevant target checks the selected-out notification information sent and decides whether or not the relevant saving data is suited for the own data storage unit. Then, response information is produced based on the decision result thereof. The response information includes a command name representative of OK or NG as to the response and a LUN and the number of LUNs, being given with a code TCP requiring response confirmation. The search response unit sends the response information toward the user (d).

Then, the user-side target search unit, when “OK” is described in the response information sent from the relevant target, decides that the data saving is possible in the data storage unit of the relevant target. Thus, data transfer is carried out to store the relevant data in the data storage unit of the relevant target (e).

Meanwhile, the response information sent from the target, when “NG” is described therein, represents that the relevant data cannot be saved in the data storage unit of the relevant target. Accordingly, another target is selected according to the accepted priority information contained in another piece of response information of those received within the foregoing time. The user-side target search unit carried out the selection of the next candidate for data saving, according to the similar procedure to the first selection of target.

Here, in the case that response information containing “NG” is successively sent from the selected target and data saving is impossible on all the targets sent the response information, the relevant data save request fails thus ending the user-side operation as to data saving.

As described above, in the data storage system of the invention, target search units are provided respectively in a plurality of initiators and a plurality of targets, thus making use of a broadcast function of target search information in the target search unit and a suitability decision function as to data storage in the target search unit. Consequently, when there is a data save request from a host or another target, destination candidates of saving are selected out of a plurality of targets, to decide a destination of data storage in an autonomous fashion. Therefore, trouble in a manager's operation is relieved, to reduce management cost as compared to the conventional data storage system.

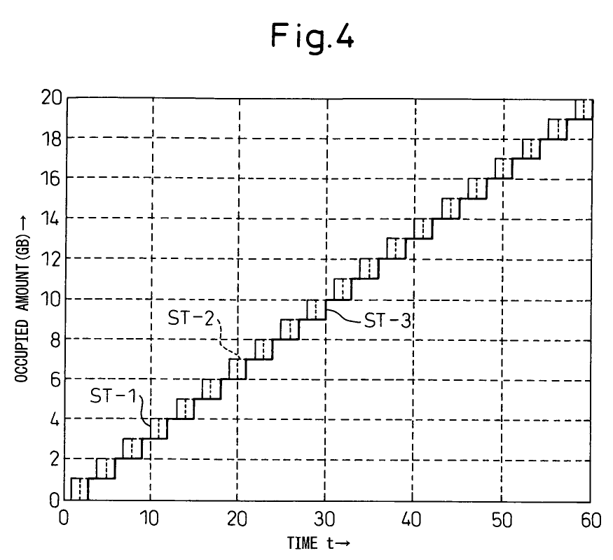

Referring to FIGS. 4 to 12, explanation is now made of the accepted priority information produced in each target in response to the target search information broadcast onto the network.

As described above, in the data storage system shown in FIGS. 1 to 3, the plurality of data storage devices are each made autonomous and further the server function is decentralized to enable autonomous search for a destination of data saving, thus realizing read and write of data, autonomous movement of data, autonomous restoration of data and so on. However, when considering a failure of the data storage device where connecting a plurality of data storage devices and decentralization is utilized in data storage as in the present data storage system, there is a need to sporadically distribute the storing data to a possible extent. Furthermore, when considering the access speed of the data storage device, read and write accesses must be made sporadic to a possible extent.

Therefore, in target selection for storing data to each of the data storage device in the data storage system of the invention, the accepted priority information contained in response information is utilized upon selecting a target depending upon the response information of from the target, thereby equalizing the occupied amount between the data storage devices and dispersing accesses. Below, an explanation is made as to producing accepted priority information in each of the targets.

FIG. 4 shows a concrete example that an occupied amount equalization and access dispersion are realized in the case the data storage units of the targets connected to the data storage system are equal in storage capacity wherein the available capacity of the own data storage unit is included as accepted priority information produced in the target. In FIG. 4, 200 GB is exemplified as an equalized storage capacity, to provide the final data amount for data storage of 600 GB.

FIG. 4 shows a manner that the user's target search unit selects a target depending upon the accepted priority information contained in response information received, thus saving data. The selected targets are, for example, targets 1, 2 and 3, thus showing a graph illustrating the manner that data is saved in the data storage units ST-1, ST-2, ST-3 thereof. Incidentally, time is shown on the abscissa of the graph while an occupied amount of the data storage unit is shown on the ordinate.

At first, when the user broadcasts target search information, the search response unit in each target receives the target search information and decides whether the relevant data is possible to save in the own data storage unit by referring to the number of LUNs of the storing data contained in the information and the current available capacity in the own data storage unit. At this time, the size of storing data represented by the number of LUNs is 1 GB, for example. At this time, in the concrete example shown in FIG. 4, each data storage unit is in an empty state free of data storage. Each target decides that data storage is possible, and produces response information by including the available capacity of the own data storage unit in its accepted priority information, thereby broadcasting it onto the network. The available capacity included in the accepted priority information is 20 GB.

Here, target selection is done on the user side, as shown in FIG. 3 at its user side. The user-side target search unit, receiving the response information, is to select a target as a destination of data saving depending upon the available capacity contained in the accepted priority information, wherein listing is done in the order of greater available capacity in order to select one out of those higher in the order.

In the FIG. 4 case, because available capacity is equal on all the targets, the targets 1 to 3 are selected as destinations of data saving, to make a selected-out notification in the order of from the target 1. Data is sent in the order of starting from the one replied “OK”, e.g. to the target 1 at time lt where the data of 1 GB a time is stored in the data storage unit ST-1. At time 2t deviated from the time it, data is sent to the target 2 where the data of 1 GB a time is stored in the data storage unit ST-2. Then, at time 3t deviated furthermore, data is sent to the target 3 where the data of 1 GB a time is stored in the data storage unit ST-3.

By repeating the above search procedure, the data of 1 GB a time is stored in order from the user side in the targets 1, 2, 3 while deviating access time. In the target search next repeated, the available capacity, included in the accepted priority information produced on the target side, has a size decreased 1 GB each time repetition is done. In this manner, the 60-GB data sent from the user side is saved in three targets equal in storage capacity while being equalized in unoccupied amount and dispersed in accesses.

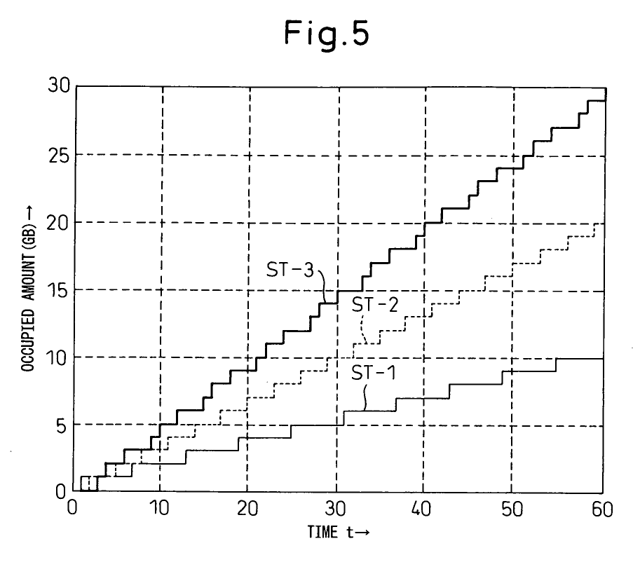

In the target search concrete example in FIG. 4 explained so far, the data storage units of the targets, all the three, had the equal storage capacity. FIG. 5 shows a concrete example on a case that the data storage units of the three targets are not equal in storage capacity. Here, it is assumed that the data storage unit ST-1 has a storage capacity of 10 GB, the data storage unit ST-2 a storage capacity of 20 GB and the data storage unit ST-3 has a storage capacity of 30 GB.

The target search procedure in the case shown in FIG. 5 is similar to the case shown in FIG. 4. However, in the FIG. 5 case, the accepted priority information produced in the target employs an unoccupied ratio in the data storage unit, in place of available capacity. The unoccupied ratio is to be operated by the accepted information processing unit in the target and included upon broadcasting response information onto the network.

In case the accepted priority information employs an unoccupied ratio, the reason of adopting an unoccupied ratio is that, in the case the data storage units in any have unequal storage capacities, access concentration occurs on the target greater in storage capacity. By taking an unoccupied ratio as accepted priority information in place of available capacity, occupied amount can be equalized with dispersed accesses.

The accepted priority information, produced in the accepted information processing unit of the target, is received at the user-side target search unit and listed up in the order of greater unoccupied ratio. The user-side target search unit selects targets in the order of greater unoccupied ratio. As a result, the data storage unit is move likely to be selected, as the storage capacity thereof is greater.

As shown in FIG. 5, the data of 1 GB a time of from the user side is saved on a one-target basis. The access frequency to the data storage unit, for data storage, differs depending upon the magnitude of storage capacity in the data storage unit. The access frequency to the data storage unit ST-2 is two times the access frequency to the data storage unit ST-1. The access frequency to the data storage unit ST-2 is two times the access frequency to the data storage unit ST-1. The access frequency to the data storage unit ST-3 is three times the access frequency to the data storage unit ST-1. As for the timing of storage, the data storages to the data storage units ST-1, ST-2 and ST-3 are all deviated in timing by a time lt.

As shown in FIG. 5, by repeating the search procedure, the data of 1 GB a time is sequentially stored from the user side to the targets 1, 2, 3 while deviated in access time. In the next target search repeated, the unoccupied ratio, included in the accepted priority information produced on the target side, is in a size reduced by 10% a time for the target 1 each time repeated, by 5% a time for the target 2n and by 3.33% a time for the target 2.

For example, at time point 4t, the data storage unit ST-1 has an unoccupied ratio of 90%, the data storage unit ST-2 has that of 95% and the data storage unit ST-3 has that of 96.7%. Accordingly, the user-side target search unit, when selecting targets, is to select those unoccupied ratios in the order of greater unoccupied ratio included in the accepted priority information sent from the targets. Thus, the target 3 is selected with priority.

In this manner, the 60-GB data sent from the user side is divided into three targets as 10 GB, 20 GB and 30 GB, thus being separately saved with unoccupied amount equalization and access dispersion.

In the FIG. 4 case, there is shown a concrete example that the data storage units of the targets, connected to the data storage system, are equal in storage capacity, to include available capacities of the own data storage units as accepted priority information produced in the targets thus realizing occupied amount equalization and access dispersion. However, during data storage, there is a possibility that the system be newly added with a target having an empty data storage unit identical in storage capacity. Otherwise, there might be erased the data saved in the data storage unit of the target connected to the system. These are possibly taken as subjects of target selection as to the data storage of from the user side to the target.

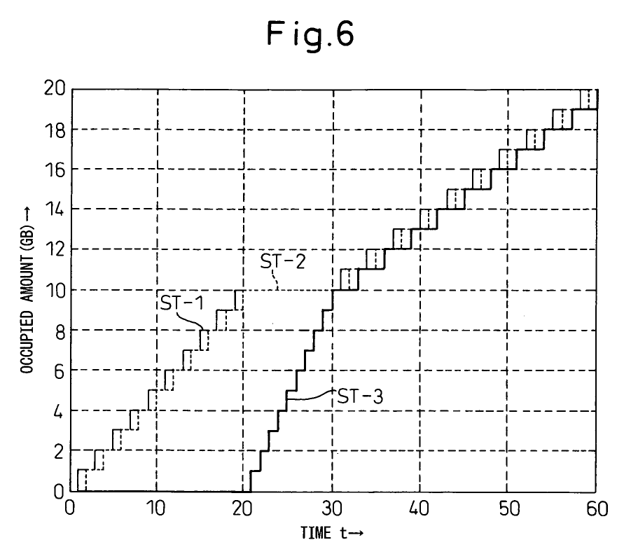

Such a case is shown in FIG. 6. In FIG. 6, the targets 1 and 2 are first selected wherein the data of 1 GB a time is stored, in order, in the data storage units ST-1 and ST-2. However, a new target 3 is added at time 20t.

Here, where available capacity is adopted as accepted priority information produced upon target search, the user-side target search unit selects target in the order of greater available capacity. Accordingly, the target 3 only is to be selected up to time 30t when the data saving amount of the data storage unit ST-3 thus added becomes equal to the data saving amount of the other data storage units ST-1, ST-2.

In this state, accesses for data saving are concentrated on the added target because of averaging the occupied amount over the storage system entirety, thus resulting in a problem of lowering in the overall data storage rate. Incidentally, even if an unoccupied ratio is adopted in place of available capacity, a similar problem occurs in case the data storage units of the targets are equal in storage capacity.

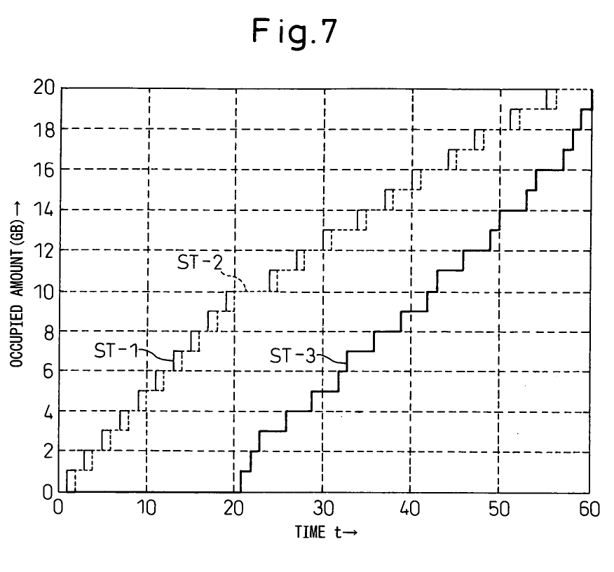

Accordingly, in the target search case shown in FIG. 6, there is shown in FIG. 7 a concrete example of target search wherein, during producing accepted priority information, accepted priority information is changed between the cases the own target is selected and not selected. By producing accepted priority information to be changed between the two cases, the degree of selection is moderated for the added target thus preventing the access to a particular target from increasing during data storage.

Here, an explanation is made as to producing accepted priority information about the own target in the accepted information processing unit of each target in order to make a response to the broadcast target search information. The accepted priority information includes a priority index so that target selection can be made in the user-side target search unit based on the magnitude of the priority index. In producing such a priority index, an access coefficient is introduced which reflects, in the index, whether or not selected in the last access. How to introduce the same is explained separately with cases 1 and 2.

(Case 1)

For accepted priority information, an unoccupied ratio of the data storage unit of the target is employed to calculate a priority index from the unoccupied ratio. At first, when the unoccupied ratio as to the m-th target is taken as Rₘ and the access coefficient as Aₘ, the priority index Xₘ can be expressed as in the following.
Xₘ=Aₘ×Rₘ (1)

Here, in the case the data storage system is in a configuration shown in FIG. 1, m=1, 2, . . . , M is given.

Thus, access parameter K is introduced in determining access coefficient Aₘ. In the case the own target was selected as a destination of data saving in the last time, access coefficient Aₘ is determined according to the following equation provided that the access coefficient on the x-th access is Aₓ₋₁.
Aₘ=K×Aₓ₋₁ (2)
From equation (1), calculated is a priority index Xₘ for the access in this time. Here, Aₓ₋₁ means the access coefficient of the last access wherein A₀=initial value is given for the first access.

Meanwhile, in the case the own target was not selected last time as a destination of data reservation, access coefficient Aₘ is determined according to the following equation, thereby calculating a priority index Xₘ on the access in this time according to equation (1).

Here, in case the access parameter K is set at a proper value selected from a range 0<K≦1, e.g. K=0.5, the initial value A₀ of the access coefficient Aₘ can be given as A₀=1. Accordingly, in the case selected in the last access, the priority coefficient Xₘ is Xₘ=0.5 while, in the case not selected in the last access, the priority index Xₘ is as Xₘ=2. Incidentally, the setting of K=1 results in the similar to the showing in FIG. 6.

In this manner, the priority index Xₘ is changed in magnitude between the cases selected in the last access and not selected. When the priority index Xₘ is included in the accepted priority information of the response information and the user-sided target search unit selects a target as a destination of data saving, the degree of selection is changed.

As shown in FIG. 7, when the target 3 is added at time 20t to the storage system, accesses in the initial stage are continuously to the data storage unit ST-3 of the target added, thus increasing the amount of data saving. However, thereafter, accesses are also to the targets 1 and 2. While storing data also to the data storage units ST-1 and ST-2, data storage is made to the data storage unit ST-3.

In this manner, by determining a priority index Xₘ by use of equations (2) and (3), generated is an effect that the priority in selection is lowered for the target selected in the immediately preceding access while the priority in selection is raised for the target not selected in the immediately preceding access. Thus, accesses can be dispersed while equalizing the unoccupied amount in each of the data storage units.

(Case 2)

In case 1, the technique of changing the priority index Xₘ separately uses the multiplication and division of the access parameter K on the access coefficient Aₘ depending upon whether or not a target was accessed in the last time, as described before. With the technique of case 1, where the targets connected to the storage system are many in the number, there is an exponential increase in the priority index Xₘ produced in the target that non-selected state continued, which results in an extremely great value. Accordingly, such a great value incurs trouble in managing the priority index on the user side.

Therefore, in case 2, the method of calculating an access coefficient Aₘ is devised not to allow the priority index Xₘ to become great in value. In determining an access coefficient Aₘ, an access parameter K is introduced to determine an access coefficient Aₘ according to equation (2) in the case the own target was selected last time as a destination of data saving. Thus, by equation (1), calculated is a priority index Xₘ on access in this time.

Meanwhile, in the case the own target was not selected last time as a destination of data saving, an access coefficient Aₘ is determined according to the following equation, thereby calculating a priority index Xₘ on the access in this time according to equation (1).
Aₘ=Aₓ₋₁+K×(1−Aₓ₋₁) (4)
Here, the access parameter K is set at a suitable predetermined value selected from the range 0<K≦1.

For example, with a setting K=0.5, in case the initial value A₀ of the access coefficient Aₘ is taken A₀=1, the priority index X is given X=0.5 in the case selected in the last access. When not selected in the last access, the access coefficient Aₘ is given as Aₘ=1. With a setting K=0.5, in the case non-selection continued, the access coefficient Aₘ is Aₘ=1 at all time while the priority index Xₘ continues the magnitude as it is in unoccupied ratio Rₘ. Meanwhile, in the case selected, the access coefficient is Aₘ=0.5 wherein, in the case selected also in the next access, the access coefficient is Aₘ=0.25, thus decreasing the priority index Xₘ.

In this manner, in case 2, the access coefficient Aₘ in the selected case is provided less than the access coefficient Aₘ in the non-selected case. For the target last selected, calculated is an access coefficient Aₘ so that the relevant target is not easily selected.

In the meanwhile, although the initial value A₀ of the access coefficient Aₘ is rendered A₀=1 in the above example, the initial value can be set by a selection out of a range 0<A₀≦1. For example, if set as A₀=0.5, the access coefficient Aₘ in the case selection continues exponentially decreases as 0.25, 0.125, . . . Meanwhile, the access coefficient Aₘ in the case non-selection continues is a value gradually approaching 1, e.g. 0.75, 0.875, . . .

In case providing a setting K=1 by setting the initial value of the access coefficient smaller than 1, the result is similarly to the showing in FIG. 6.

In this manner, the priority index Xₘ is changed in magnitude between the cases selected in the last access and not selected. Accordingly, when the priority index Xₘ is included in the accepted priority information of response information and the user-side target search unit selects a target as a destination of data saving, the degree of selection is changed. Similarly to the case 2 example, the access coefficient Aₘ for the case selected is calculated less than the access coefficient Aₘ for the case not selected. Those selected targets are not readily selected furthermore.

Incidentally, in the case of the access coefficient Aₘ calculation method in the case 1, restoration is earlier in the non-selected case because the access parameter K is equal in value between the selected case and the non-selected case. However, where the targets connected to the storage system is great in the number, the access coefficient Aₘ itself is in a value greater than 1. On the contrary, in the case of the access coefficient Aₘ calculation method in the case 2, restoration is moderate for the case of not being selected. This accordingly is effective for sequential selection where the targets connected are great in the number.

In the cases 1 and 2 explained so far, the unoccupied ratio Rₘ of the data storage unit of each target was used in determining a priority index Xₘ. Explanation is now made on case 3 adapted to change the definition of unoccupied ratio Rₘ when a new target is added so that, when a target having an empty data storage unit is added to the storage system, accesses concentration to the added target can be suppressed, as shown in FIG. 6.

(Case 3)

In the usual search for selecting a target already connected to the storage system as a destination of data saving, the unoccupied ratio Rₘ is determined according to the following equation provided that the total capacitance of the data storage unit is C₀ and the occupied amount at the x-th access to the m-th data storage unit is Cₓ.
Rₘ=(C₀−Cₓ)/C₀ (5)
Thus, the priority index Xₘ can be determined according to equation (1). Here, the access coefficient Aₘ is taken, for example, Aₘ₌1, to use unoccupied ratio Rₘ itself as accepted priority information.

After additional connection of a target having an empty data storage unit to the storage system connected with a plurality of targets, unoccupied ratio Rₘ is to be determined by switching to equation (6) from equation (5) for usual use.
Rₘ=(C₀−Cₓ)/Eₘ (6)

Here, Em is an available capacity in the case an empty data storage unit is newly added.

Broadcast to the targets is the fact that the target having an empty data storage unit is newly added to the storage system. The targets are allowed to detect the addition of a new target, according to the broadcast. When each target receives the detection of a new target added, the accepted information processing unit of the target switches from equation (5) over to equation (6) in calculating a priority index Xₘ at a detection time and subsequent.

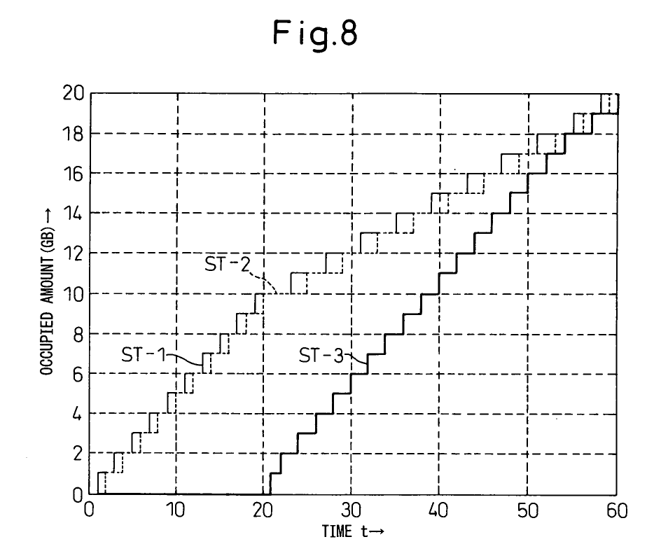

FIG. 8 shows an example for selecting a target as a destination of data saving according to a priority index Xₘ determined by the approach of case 3 shown in the above. Before time 20t, the data storage units ST-1 and ST-2 are selected alternately with a time deviation of it according to the priority index Xₘ based on equation (5), thus effecting data saving in an amount of 1 GB a time. At time 20t, when a target 3 having an empty data storage unit ST-3 equal in capacity is directly added to the system, a switchover of from equation (5) to equation (6) is effected in the respective accepted information processing units of the targets 1 to 3, to determine a priority index Xₘ at the addition time and subsequent.

In this manner, even in the state a new target is added in mid course to the storage system, the 60-GB data sent from the user side is saved in the three target having the equal storage capacity while equalized in unoccupied amount and dispersed in accesses.

In the examples of cases 1 to 3 explained so far, in the case the data storage units of the targets connected to the storage system are all of the same storage capacity as shown in FIG. 4, even in case a new target is additionally connected in mid course, the priority index is included in priority information devised in access coefficient calculation to select a destination of data saving for occupied amount equalization and access dispersion.

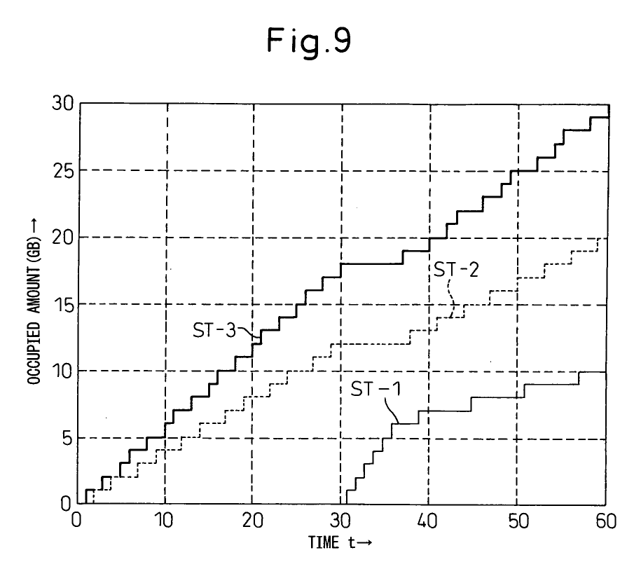

Meanwhile, also in the case the data storage units of the targets are not equal in storage capacity as shown in FIG. 5, when a new target is added in mid course as shown in FIG. 9 similarly to the case of selecting the targets equal in storage capacity, there is a problem that access concentration at a destination of data saving occurs on the added target.

In FIG. 9, the data storage unit ST-2 of the target 2 has a storage capacity of 20 GB, the data storage unit ST-3 of the target 3 has a storage capacity of 30 GB. The targets 2 and 3 are first selected to save data of 1 GB a time in the data storage units ST-2 and ST-3, in order. At time 30t, a new target 1 is added.

Here, where unoccupied ratio is adopted as accepted priority information to be produced upon target search, the user-side target search unit selects targets in the order of greater unoccupied ratio. Accordingly, the target 1 only is selected by time 36t at which the data storage unit ST-1 added has an unoccupied ratio equal to the unoccupied ratio of the other data storage unit ST-2, ST-3.

In this state, there is a concentration of accesses for data saving in the added target in order to equalize the occupied amount over the storage system overall. Likewise the FIG. 6 case, there is a problem of lowering in the overall data storage rate.

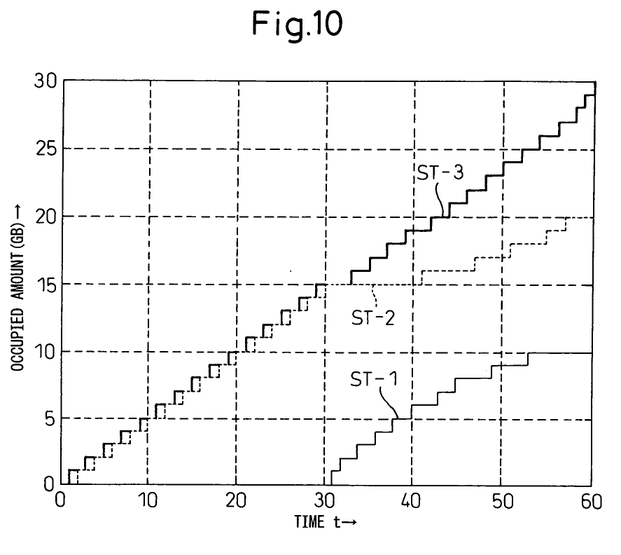

Accordingly, in the target search case shown in FIG. 9, it is possible to employ the case 1 or 2 that how to determine a priority index Xₘ, to be included in accepted priority information, is changed between the cases the own target is selected and not selected upon producing accepted priority information. The application example of same is shown in FIG. 10. In the case shown in FIG. 10, before adding of a new target 1, the available capacity of the target storage unit ST-2, ST-3 is used as accepted priority information. After time 30t a new target 1 is added, switching is made to use, as accepted priority information, the priority index Xₘ shown in case 1.

As can be seen from a graph representing a data saving state shown in FIG. 10, the data storage units ST-2 and ST-3 are alternately selected with a time deviation of it before reaching time 30t, thus saving data of 1 GB a time. In case, at time 30t, the target 1 having a data storage unit ST-1 having a storage capacity of 10 GB is additionally connected to the system, the respective accepted information processing units of the targets 1 to 3, after the time 30t the addition has been detected, uses the equations (2) and (3) of the case 1, to determine a priority index Xₘ to be included in response information.

In this manner, even when a new target is added, in mid course, to the storage system during the connection of a plurality of targets not equal in storage capacity to the storage system, the 60-GB data sent from the user side is saved in the three target having storage capacities of 10 GB, 20 GB and 30 GB while being equalized in occupied amount and dispersed in accesses.

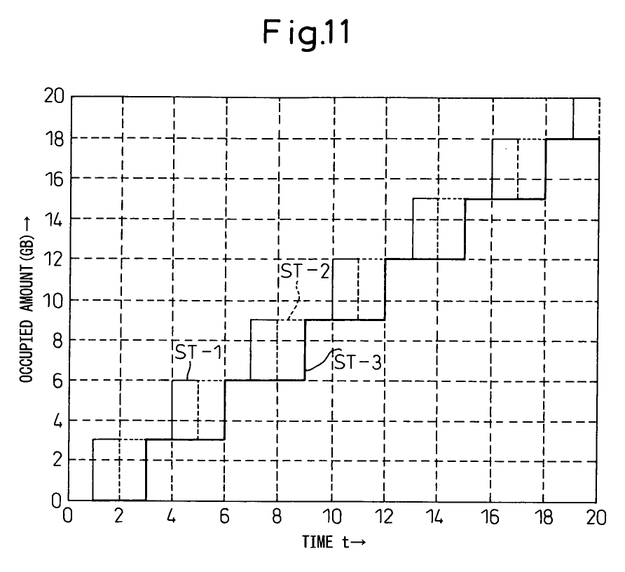

In the above explanation, in any of the cases shown in FIGS. 4 to 9, the user side who intends to save data was one user. However, where adopting the data storage system arrangement shown in FIG. 1, the user who requests data saving is not limited to one user. Therefore, explanation is made on a case that a plurality of users are allowed to select a destination of data saving with reference to FIG. 11.

(Case 4)

FIG. 11 shows a manner that three users have simultaneously accesses to the targets 1 to 3 connected to the storage system thereby saving data therein. Here, the procedure the three users select targets as destinations of data saving adopts the target-search process procedure shown in FIG. 3. The three users are on the user side shown in FIG. 3. When the users search a plurality of target-side targets as a destination of data saving, target search information is broadcast from each of the users onto the network. The subsequent process procedure of target search by the users is similar to the user-side process procedure described related to FIG. 3.

In FIG. 11, shown is a concrete example realized occupied amount equalization and access dispersion in the case the data storage units of the targets connected to the data storage system are equal in storage capacity wherein the unoccupied ratio of the own data storage unit is included as accepted priority information produced in the target. The equal storage capacity is exemplified with 20 GB, thus providing the final amount of data for data saving of 60 GB.

FIG. 11 shows a manner that the target search units of the three users select targets, depending upon the accepted priority information contained in the received response information received, and then save data. The targets selected by the three users are target 1, 2 and 3, showing a manner that data is saved in the data storage units ST-1, ST-2, ST-3 thereof with a time deviation of lt. Because 1-GB data is sent from each of the users, the data once stored to the data storage units ST-1, ST-2, ST-3 is 3 GB at a time.

In the case shown in FIG. 11, the user, when selecting targets as a destination of data saving, is to select targets in the order of greater in the unoccupied ratio contained in the received response information. Accordingly, in case the plurality of users have accesses simultaneously, selections are concentrated on one target as a destination of data saving, thus effecting data saving. Even in the case the unoccupied ratios of the targets are equal, selections are in the order of earlier in response, thus resulting in the same target selection by all the users.

For this reason, as shown in FIG. 11, selections of a destination of data saving concentrate on one target. In order to suppress it, an access coefficient Aₘ taking a random value is introduced in producing accepted priority information to be included in response information about the target. The accepted information processing unit of the target is configured to calculate a priority index Xₘ according to the foregoing equation (1). Here, the access coefficient Aₘ is set as a random value in a range of from 1 to 0.9.

In this manner, by using a random-valued access coefficient in calculating a priority index Xₘ on a target-by-target basis, even in case the unoccupied ratios Rₘ are equal between the targets, the priority indexes Xₘ included in response information are different in value because the access coefficients are random in value. Accordingly, it is possible to reduce the possibility for the users to select targets concentratedly on the same target. Thus, access dispersion can be achieved.

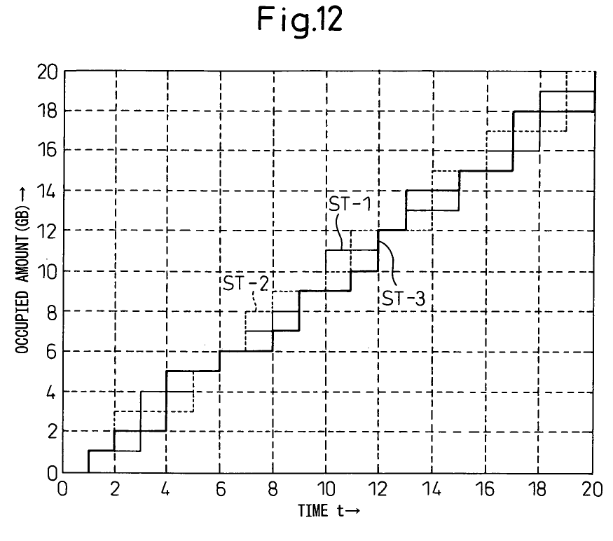

Here, there is shown in FIG. 12 an example that a plurality of users are to select targets according to priority index Xₘ using a random-valued access coefficient Aₘ. The data storage units of the targets all have a storage capacity of 20 GB similarly to the FIG. 11 case. The three users are allowed to send data of 1 GB a time.

For example, at time lt, the three users separately select target 1, 2 or 3, to save 1-GB data to data storage units ST-1, ST-2, ST-3, respectively. The priority indexes Xₘ are respectively calculated in accepted information processing units of the targets when responding to the broadcast of target search information. Accordingly, the priority index Xₘ of the own data storage unit is different from the priority index Xₘ value even in case, at this time point, equal to the unoccupied ratio Rₘ of the data storage unit of another target.

Consequently, at time point 2t, no users access the target 2. One user accesses and selects the target 3 and saves 1-GB data in its data storage unit ST-3 while two users simultaneously access and select the target 2 and save 2-GB data to the data storage unit ST-2.

In this manner, each time the user accesses the target, a priority index variable random is calculated. This can prevent all the three users from simultaneously select the same target, i.e. the three users are respectively allowed to select different targets. When a plurality of users save data into a plurality of targets, access dispersion or leveling can be achieved while equalizing the occupied amount.

Incidentally, in the above, when the unoccupied ratio of the own data storage unit is used for the priority index Xₘ of the target during selecting a destination of data saving on the user side, calculation was made such that an access coefficient becomes a random value, as an approach to avoid from becoming an unoccupied ratio equal to the unoccupied ratio of another target. However, the approach for access leveling is not limited to this technique. It is also effective to delay randomly the timing of sending out accepted priority information to be sent from the target.

On the user side, when the priority indexes Xₘ contained in the response information are equal, selection as a destination of data saving is in the order of earlier response from the target. Accordingly, by intentionally delaying the timing of sending accepted priority information from the target, leveling can be achieved together with dispersion of accesses to the target even in case the priority indexes Xₘ are equal.

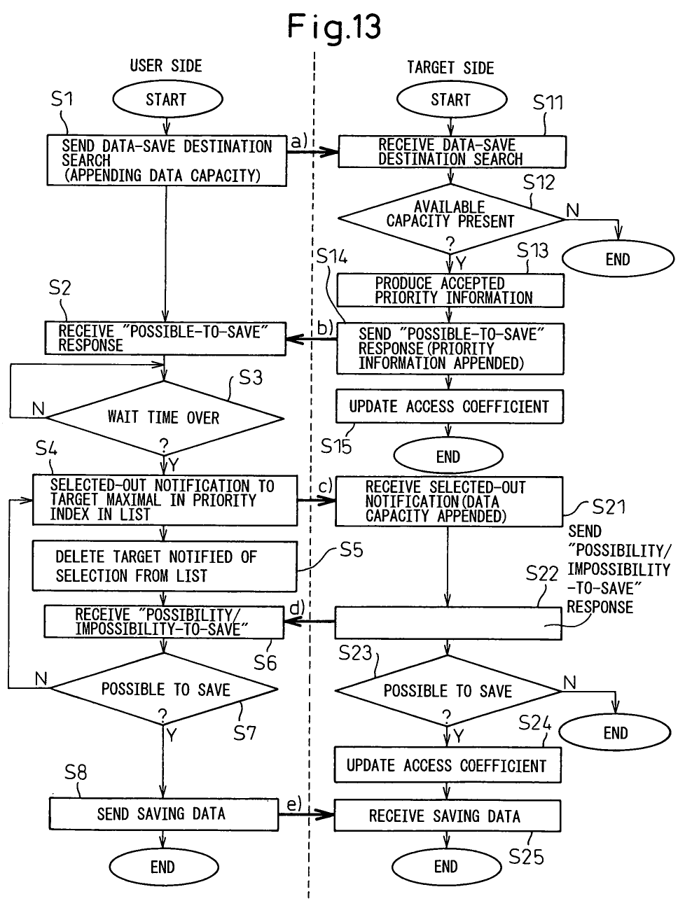

As described above, an explanation was made that by using a priority index Xₘ and devising a way for determining its value during a target search made for a destination of data saving from the user side, occupied amount equalization and access dispersion are to be achieved upon data saving into a plurality of targets connected to a data storage system. Referring to a flowchart shown in FIG. 13 as to a procedure of target search shown in FIG. 3, explanation is now made on a further detailed process procedure during target search.

In the FIG. 13 flowchart, the communication status on the user and target sides wholly corresponds to the process procedure of the FIG. 3 target search. The “user side” and “target side” in FIG. 13 corresponds to the user side and target side in FIG. 3, wherein the information flows shown at bold arrows a) to e) correspond to the information flows a) to e) in FIG. 3.

The user-side flow in FIG. 13 represents a process procedure in an initiator or target which is to select a destination of data saving in order to save data (steps S1 to S8). The target-side flow represents, at its upper, a process procedure in each target to which target search information is broadcast from the user side (steps S11 to S17) and, at its lower, a process procedure in a target selected as a destination of data saving (steps S21 to S26).

It is first assumed that any of the initiators 1-N and targets 1-M connected to the data storage system is a user wherein there arises a need for the user to search for a target as a destination of data saving. At this time, on the user side, the target search unit provided on the user side starts an operation and broadcasts automatically-produced target search information onto the network (step S1). The target search information includes a command name meaning a target search and a number of LUNs representative of a capacity of storing data as described before, being attached with a code UDP representative of not to confirm a response. The target search information is to be simultaneously broadcast according to a network protocol (flow “a”).

Meanwhile, on the target side including a plurality of targets, the broadcast target search information is received by search response units provided respectively (step S11). Then, the accepted information processing unit of the target, received as the target search information, decides an unoccupied status or occupied status of the relevant data storage unit according to the number of LUNs included in the received target search information (step S12).

Here, when it is decided in each target that its own data storage unit has an available capacity capable of storing data (Y at step S12), the accepted information processing unit produces accepted priority information (step S13). The accepted priority information includes an available capacity or unoccupied ratio of the own data storage unit or a priority index Xₘ according to any of cases 1 to 4.

Here, the search response unit, in the case produced accepted priority information, produces response information containing the accepted priority information in order to respond to the target search information received. After provided with a code UDP meaning not to confirm a response, the response information is sent onto the network (step S14, flow “b”). Then, in the case a priority index Xₘ according to any of the cases 1 to 4 is not contained in the accepted priority information sent, an access coefficient Aₘ is calculated and saved (step S15).

Meanwhile, at step S12, when it is decided in each target that there is no available capacity capable of storing data in the own data storage unit (N), the accepted information processing unit does not produce accepted priority information, to not make any response to the received target search information. In this case, the access coefficient Aₘ is not updated. For example, the initial value of the access coefficient is saved.

Then, at step S14, when response information is broadcast from each target, the user receives a response based on the response information broadcast as a candidate of a destination of data saving in this time (step S2). Here, the user's target search unit waits for a predetermined time, e.g. for 10 seconds, from the broadcast of target search information until the respective pieces of response information from the targets are completed, in consideration of such a problem as congestion over the network (step S3).

Then, the user's target search unit reads accepted priority information representative of a capability of saving data out of the completed pieces of response information on a target-by-target basis and lists up those in the order greater in the value thereof. The target, corresponding to the highest ranked accepted priority information, is selected as an optimal destination of data saving. Selection notifying information, representative of a fact being selected as a destination of data saving, is sent to the target (step S4, flow “c”).

Simultaneously with transmitting the selected-out notification information, the target the relevant notification has been sent is deleted from the list (step S5). By the deletion, the next-ranked selection candidate is raised to the top priority candidate in the next target selection.

This selected-out notification information is received by an objective target to be selected (step S21). This information includes a command name representative of the fact selected as a destination of data saving, a number of LUNs representative of a size of the data to be saved and data identification information about securing a domain, being given with a code UDP representing to confirm a response.

Consequently, when the selected-out notification information is sent to the relevant target, the search response unit of the target decides whether or not it is suited for data saving by again referring to the number of LUNs contained in the selected-out notification information because of a possible change in the data storage status of the relevant target. Then, produced is response information about a saving possibility/impossibility representative of a possibility/impossibility to save data this time, and this response information is sent to the user (step S22, flow “d”).

Thus, the user's target search unit receives the response information from the target which the selected-out notification has been sent (step S6). Based on the response information, it is decided whether or not the relevant target is suited as a destination of data saving (step S7).

Then, the user-side target search unit, when “OK” is described in the response information sent from the target (Y at step S7), decides that the data is possible to save in the data storage unit of the relevant target. Thus, data transfer is effected to store the data in the data storage unit of the relevant target (step S8, flow “e”).

Meanwhile, in the case “NG” is described in the response information sent from the relevant target (N at step S7), it is represented that the data cannot be saved in the data storage unit of the target. Accordingly, the process returns to step S4 where the target, whose accepted priority information is in the top ranking in the foregoing reception list, is selected as the next candidate.

Here, although omitted in the FIG. 13 flowchart, in the case response information containing “NG” is successively sent from the selected targets wherein data saving was not possible on all the targets sent the response information as shown in FIG. 3, the request for saving the data is considered failed thus ending the user-side operation for data saving.

In the meanwhile, when at step S22 the response information sent to the user is sent, in the case “OK” the data saving in this time is possible is included therein (Y at step S23), the access coefficient Aₘ is updated (step S24) because corresponding to “the case selected” upon calculating a case 1 or 2-based priority index Xₘ at the step S12. Then, the saving data, shown at step 8, sent from the user is received and stored in the own data storage unit (step S25).

Meanwhile, in the case that, at step S23, “NG” the data saving in this time is possible is included in the response information sent to the user (N), it corresponds to “the case not selected” upon calculating a case 1 or 2-based priority index Xₘ at the step S12. However, because the access coefficient Aₘ has been already updated at S15, update is not done in this case. Thus, data saving is not done in this time.

Incidentally, explanation is made here as to a calculation for updating the access coefficient Aₘ. In the case of using the target selection scheme according to the invention, a selected-out notification is delivered to the target selected so that the target side can recognize the fact the own target has been selected. Meanwhile, because no selected-out notification is made to the target not selected, the target side cannot recognize the fact it is not selected. For this reason, in all the targets responded “possible-to-save”, an access coefficient Aₘ is calculated as a case not selected. As to the target actually selected, an access coefficient Aₘ for selected case is calculated in consideration thereof. For example, for the case 1, an access coefficient Aₘ is calculated at step S15 by using the foregoing equation (3). At step S24, an access coefficient Aₘ calculated by use of the following equation (7) in consideration of the foregoing equation (2).
Aₘ=K×K×Aₓ₋₁ (7)

As in the above, in the data storage system according to the invention, target search units are respectively provided in a plurality of initiators and a plurality of targets that are included in the data storage system, thereby utilizing the broadcast function of target search information in the target search units and suitability decision function of data saving in the target search units. With the suitability decision function, accepted priority information can be automatically produced in the accepted information processing unit of the target, thus enabling target selection depending upon the accepted priority information. Accordingly, when data saving is requested from the host or another target, the optimal candidates of destinations of saving can be selected from the plurality of targets, to autonomously decide a destination of data saving. Therefore, troubles in a manager's operation is relieved to reduce a management cost as compared to the conventional data storage system. Thus, it is possible to equalize the occupied amount of the data storage unit in each of the targets and further disperse the accesses for data saving.

Incidentally, in the case the unoccupied ratio Rₘ of the data storage unit of the target is used as the accepted priority information explained so far, the target greater in unoccupied ratio is selected as a destination of data saving. Furthermore, although access concentration occurred on the particular target with a quick response, target selection can be made random with a probability dependent upon the size of the priority information sent from the target when target selection is made on the user side depending upon the unoccupied ratio Rₘ.

Here, when the unoccupied ratio of the m-th target is taken Rₘ and the probability of target selection to the m-th target is taken Pₘ, the probability Yₘ is calculated by the following equation.
Yₘ=Rₘ/(R₁+R₂+ . . . +R_{M}) (8)
In equation (8), the term (R₁+R₂+ . . . +Rₘ) represents an unoccupied ratio of the data storage units of the targets 1 to M shown in FIG. 1, which represents the sum of unoccupied ratios of the targets responded to the target search information in this time sent from the user side.

The user-side target search unit, when selecting targets as destinations of data saving, calculates the equation (8)-based probabilities Yₘ on each responded target, based on the unoccupied rate Rₘ contained in the accepted priority information sent from the target. Then, the user-side target search unit selects target randomly depending upon the target-based probability Yₘ calculated commensurate with the magnitude of priority. Such a selection manner can be referred to as probabilistic selection.

In this manner, access leveling is enabled by the probabilistic selection according to equation (8), in the user-side target search unit.

Then, explanation is made herein on an embodiment of a target search process procedure, in a data storage system of the invention, in the case there is a request for data storage from the host to a plurality of targets of the storage system.

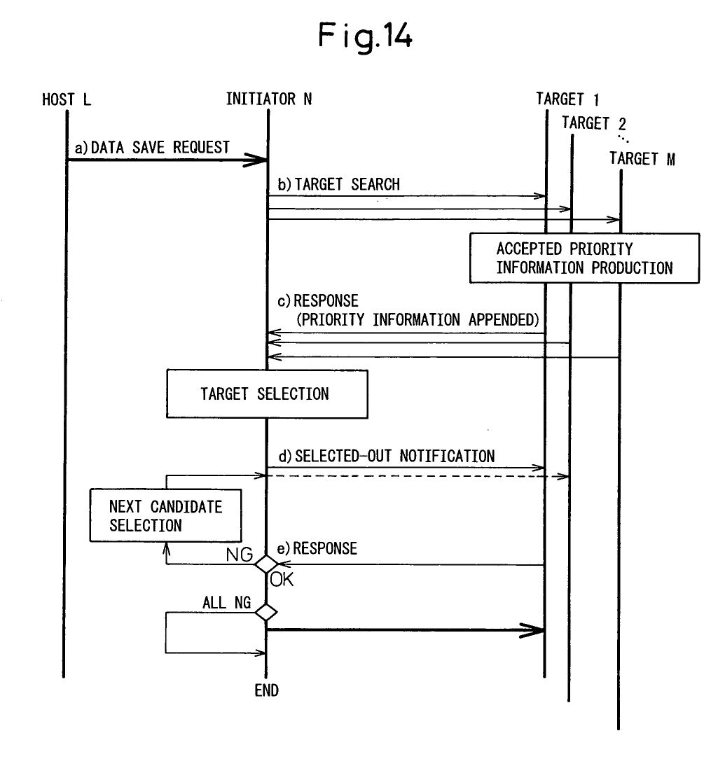

The target search process procedure in this embodiment is shown in FIG. 14. The flowchart in FIG. 14 shows a case that a request for data storage is sent from the host to the targets, wherein the user side in the flowchart shown in FIG. 3 corresponds to the initiator N in FIG. 14 while target side corresponds to the target 1 to M. Accordingly, in FIG. 14, illustrated is an operation procedure of from sending a data storage request from the host L up to storing the data in the target 1 to M.

In FIG. 14, shown first is a state that a request for data storage from the host L is received by the initiator N through the network (a). Here, the host L broadcasts a request information about data storage demand onto the network so that the initiators available at this time are to make responses. In FIG. 14, the initiator N responded to the request. The request information includes data identification information.

Based on the request information, the initiator N at its target search unit TS-N starts an operation to perform a target search (b). The target search unit TS-N automatically produces target search information depending upon the request information sent. The target search information includes a command name meaning a target search and a number of LUNs (Logical Unit Number) representative of a size of storing data, being given with a code UDP representing not to confirm a response. The initiator N sends the produced target search information onto the network according to a network protocol, thus effecting a simultaneous broadcast.

Meanwhile, the targets receive the broadcast target search information by the search responding unit provided respectively. Then, the accepted information processing unit decides an available status of the data storage unit from the data storage amount in the data storage unit of the own target by referring to the number of LUNs included in the target information received, thus producing accepted priority information.

Here, the accepted priority information is selected from an available capacity Cₘ or unoccupied ratio Rₘ of the data storage unit of the own target or a priority index of any of the foregoing cases 1 to 4. However, in the case to disperse accesses while equalizing the occupied amount of the data storage unit when selecting targets as destinations of data saving, it is preferred to include the accepted priority information with a priority index Xₘ calculated according to the approach of any of cases 1 to 4.

In the case there is an available space in the data storage unit of the target, the search response unit produces response information representative of a response of data storage as to the own target. The response information includes a command name representative of a response to a target search and a communication protocol IP for the initiator N as a source. Besides those, the response information may include various pieces of attribute information about the relevant target. For example, those including a manufacturer name, data transfer rate, performance information such as of recording density, error rate, a value representative of a state of temperature or the like, and so on.

Furthermore, provided is a code UDP meaning not to confirm the response. The search response unit sends the produced response information onto the network (c). At this time, in the case there is, in a plurality of targets, available spaces commensurate with the size of data to be respectively stored in the data storage units, response information appended with accepted priority information produced similarly to the foregoing is broadcast from the respective targets onto the network 4.

Then, the target search unit TS-N of the initiator N, after sending the target search information, waits for 10 seconds only for example, for receiving response information. The initiator N, in this duration, receives the response information containing a communication protocol IP for its own and stores a target IP concerning the received response information, thus listing up those in the order of magnitude of the accepted priority information.

Then, from the list, the one showing the maximum value in priority is selected as a destination of data saving. The target search unit TS-N sends selected-out notification information to the target related to the response information including the maximum priority through the network 4 (d).

Incidentally, the target selection method herein is of a manner that the priority information maximum in value is selected a target as a destination of data saving out of the gathered response information. Meanwhile, selection may be by use of the other attribute information of those in the response information or a probabilistic selection approach may be employed that is to be obtained from the priority information.

Meanwhile, a target search is not necessarily done each time the initiator receives a data saving request. Instead, a search may be made at a suitable interval regardless of a request for saving, to save the gathered empty response information in the form of a list. In the case receiving a data save request, target selection is possible by referring to the list without making a search.

Meanwhile, after preparing a response information list, a search may be made at a time when a difference is surfaced between the list and actual status.

In FIG. 14, there is shown a case the target 1 is selected as a destination of data saving wherein selection information is sent from the initiator N. The search response unit 11 of the target 1 checks the selected-out notification information sent and decides whether or not the relevant saving data is suited for the data storage unit ST-1. Then, produced is response information including a command name representative of OK or NG concerning the relevant response due to a result of the decision and an LUN and the number of LUNs and appended with a code TCP requiring a response confirmation. The search response unit 11 sends the response information to the initiator N (e).

Then, the target search unit TS-N of the initiator N, when “OK” is described in the response information sent from the target 1, decides that the relevant data is possible to save in the data storage unit ST-1 of the target 1. Thus, data transfer is effected from the host, to sore the relevant data in the data storage unit ST-1.

Meanwhile, when “NG” is described in the response information sent from the target 1, it represents that the relevant data is impossible to save in the data storage unit ST-1. Accordingly, selected is a target 2 that is received at the next timing among those of empty response information received within the foregoing time, i.e. that is related to the second empty response information if in the FIG. 14 case. Thus, the target search unit TS-N of the initiator N carries out the operation to select the next candidate for data saving, according to the similar procedure to the case selected the target 1 (d). Here, response information containing “NG” is sent successively from the selected target. In the case data saving was impossible on all the target sent the empty response information, the relevant data save request is considered failed thus ending the data saving operation as to the initiator N. A notification of a failure in the data saving request is made to the relevant host.

The embodiment explained above was on the case that a data save request was sent from the host to the target. However, in the data storage system shown in FIG. 1, in case the host makes a request for reading the data stored in the target, data reading can be effected according the request.

In the case the data required to process in the host L is necessarily read out of the data storage unit ST-1 of the target 1 for example, the initiator N receives a request for reading data from the host L through the network 4. Here, the host L broadcast request information about requesting data read onto the network so that an initiator being empty is to make a response. It is assumed that the initiator N has responded to the request. Because the request information includes data identification information, the initiator N is allowed to respond to the request.

In the initiator N, the target search unit TS-N starts an operation on the basis of the request information, thus effecting a target search. The target search unit TS-N automatically produces target search information depending upon the received request information. The target search information includes a command meaning a target search and data identification information representative of objective data to read out, being appended with a code UDP representing the meaning not to confirm the response. The initiator N sends and broadcasts the produced target search information onto the network.

Meanwhile, the targets receive the broadcast target search information by the search response units provided respectively. The search response unit decides whether or not the data-to-be-read is stored in the data storage unit of the own target, depending upon the data identification information contained in the target search information.

Here, in case the target 1, for example, stores the relevant data in the case the relevant data-to-be-read is stored in the data storage unit of the own target, the search response unit 11 produces response information about the own target. The response information includes a command representative of a response to a target search and a communication protocol IP for the source initiator N, further being given with a code UDP having a meaning not to confirm a response. The search response unit 11 sends the produced response information onto the network 4.

Then, the target search unit TS-N of the initiator N waits for receiving the response information through the network 4, for a predetermined time from the sending of the target search information. Then, the initiator N, upon receiving the response information containing a communication protocol IP for its own, sends data read request information.

This data read request information includes the number of LUNs of the to-be-read-data and data identification information about the relevant data, being given with a code TCP requiring a response confirmation. Here, the reason of again including the number of LUNs and data identification information in the data read request information to be sent from the initiator N is to cause the target 1 to again decide whether to-be-read-data exists or not because of a change in the data storage state of the target after the initiator N has sent the request information to the relevant target wherein, in a certain case, the data stored is possibly rewritten.

The search response unit 11 of the target 1 checks the data read request information sent and decides whether or not the relevant to-be-read-data is stored in the data storage unit 26. Then, produced is response information including a command name representative of OK or NO on the response due to a result of the decision, an LUN and the number of LUNs, being given with a code TCP requiring a response confirmation. The search response unit 11 sends the response information to the initiator N.

Then, the target search unit TS-N of the initiator N, when “OK” is described in the response information sent from the target 1, decides that the relevant data can be read out of the data storage unit ST-1 of the target 1. Thus, the data reading information is sent to the target 1, to read the objective data out of the data storage unit ST-1.

Here, when “NG” is described in the response information sent from the target 1, the initiator N sends a read failure notification to the host L requested for reading data. Then, the initiator 1 ends the read request operation, placed by the host L, on the data stored in the target 1.

Meanwhile, according to the data storage system in FIG. 1, although the data stored in the target 1 can be erased in the case there is a data erase request from the host L, the process procedure upon requested for data erasure is basically similar to the process procedure for a data read request. It is satisfactory to replace the command name in the data read process procedure from “read” to “erase”, in the procedure.

When the target 1 receives the data erase request information, the search response unit 11 of the target 1 checks the number of LUNs and data identification information contained in the data erase request information. Due to this, in the case the data is for erasure, the relevant data stored in the data storage unit ST-1 is erased. Then, response information, containing “OK” or “NG” representative of possibility/impossibility to erase, is sent to the initiator N.

The initiator N received the response information, when “OK” is described in the response information, ends the operation of data erase request placed by the host L. However, “NG” is described in the response information, the initiator N makes a data erase failure notification to the host L, thus ending the data erase request operation.

As described above, target search units are provided respectively in a plurality of initiators and a plurality of targets that are included in a data storage system, thus making use of a broadcast function of target search information in the target search units and a suitability decision function as to data storage in the target search units according to the acceptability priority information sent from the targets. Consequently, when there is a data save request from a host, destination candidates for saving are selected out of a plurality of targets, to autonomously decide a destination of data storage. Therefore, trouble in a manager's operation is relieved to reduce a management cost as compared to the conventional data storage system.

1. A data storage system, connected to a network and having a plurality of data storage devices for storing data related to a host computer, the data storage system wherein
the plurality of data storage devices respectively have managing units for managing the data storage devices of the owns, the managing unit comprising:
a search response unit for deciding whether or not an data storage amount based on the data storage search information is suited for data storage in the own data storage device when data storage search information sent onto the network is received; and
an accepted information processing unit for producing accepted priority information about the own data storage device in a case the storage data amount is suited for data storage in the own data storage device;
the managing unit sending the accepted priority information onto the network by including the same in data storage response information to the data storage search information, and autonomously storing the data to the own data storage device.

2. A data storage system according to claim 1, wherein the managing unit has a target search unit capable of broadcasting the data storage search information onto the network in order to store data in another data storage device connected to the network.

3. A data storage system according to claim 2, wherein the target search unit receives the data storage response information sent from the other data storage device in response to the data storage search information broadcast onto the network, and selects a data storage device for storing data depending upon the accepted priority information contained in the data storage response information.

4. A data storage system according to claim 3, wherein the target search unit counts a time up to a return of the data storage search information broadcast onto the network, and adjusts a wait time for receiving the data storage response information depending upon the time counted.

5. A data storage system according to claim 3, wherein the target search unit selects data storage devices in order the greatest in priority value concerning the accepted priority information included in the data storage response information received.

6. A data storage system according to claim 5, wherein the target search unit sends data storage search information to the plurality of data storage devices by a simultaneous broadcast onto the network, sends selected-out notification information to the data storage device responded for suitable data storage as to the data storage search information, and receives data suitability/non-suitability response information about data storage to the selected-out notification information from the data storage device.

7. A data storage system according to claim 6, wherein the accepted priority information is an available capacity of the own data storage device upon receiving the data storage search information.

8. A data storage system according to claim 6, wherein the accepted priority information is an unoccupied ratio of the own data storage device upon receiving the data storage search information.

9. A data storage system according to claim 8, wherein the accepted priority information has a priority as a priority index that an access coefficient is multiplied on an unoccupied ratio of the own data storage device upon receiving the data storage search information.

10. A data storage system according to claim 8, wherein, when the accepted information processing unit, in a mid course of the data storage, detects an additional connection of a data storage device having an available capacity greater than an available capacity of each of the data storage devices excepting the plurality of data storage devices, the priority index of the accepted priority information after detection is determined by multiplying a random value of 1 or smaller with an unoccupied ratio of the own data storage device.

11. A data storage system according to claim 8, wherein, when the accepted information processing unit, in a mid course of the data storage, detects an additional connection of a data storage device having an available capacity greater than an available capacity of each of the data storage devices excepting the plurality of data storage devices, the search response unit randomly delays transmission timing of the data storage response information including accepted priority information of after the detection.

12. A data storage system according to claim 3, wherein the target search unit calculates, depending upon a priority value included in accepted priority information of the data storage response information received from another data storage device, a probability commensurate with a magnitude of the priority value, and randomly selects the other data storage device according to the probability.

13. A data storage system according to any one of claim 1, wherein the managing unit, after receiving selected-out notification information responded to the data storage response information sent out, performs write, read or erase as to the own data storage device depending upon a process request included in the data storage search information.

14. A data storage system according to any one of claim 1, having an initiator for receiving an instruction from the host computer through the network and sending the data storage search information to a plurality of data storage device under jurisdiction associatively with the instruction by a simultaneous broadcast onto the network.

15. A data storage system according to claim 14, wherein the managing unit, in the case the data storage search information is suited for data storage in the own data storage device, sends the data storage response information about the own data storage device to the initiator through the network.

16. A data storage system according to claim 14, wherein the initiator sends selected-out notification information about selecting the data storage device to the data storage device depending upon accepted priority information included in the data storage response information sent from the data storage device, the managing unit of the data storage device, when receiving the selected-out notification information, sends data suitability/non-suitability information to the initiator in a case the data storage search information is suited for data storage in the own data storage device.

17. A data storage system according to claim 16, wherein the managing unit, in a case including data suitability response in the data suitability/non-suitability response information, performs write, read or erase data concerning the data storage search information to or from the own data storage device.

18. A data storage system according to claim 16, wherein the initiator, in a case data suitability/non-suitability response is included from the data storage device sent out the selected-out notification information, selects a next candidate of data storage device depending upon another data storage response information sent out and forwarding selected-out notification information to the other data storage device.
